(19) United States
(12) Patent Application Publication
(10) Pub. No.: US 2016/0239778 A1
(43) Pub. Date: Aug. 18, 2016

(54) SYSTEMS AND METHODS OF MANAGING HEALTHCARE PROVIDER WORKFLOW

(71) Applicant: FlowOne Lean Consulting, LLC, Menomonee Falls, WI (US)

(72) Inventor: Aneesh Suneja, Menomonee Falls, WI (US)

(73) Assignee: FlowOne Lean Consulting, LLC, Menomonee Falls, WI (US)

(21) Appl. No.: 15/047,169

(22) Filed: Feb. 18, 2016

Related U.S. Application Data
(60) Provisional application No. 62/117,546, filed on Feb. 18, 2015.

(51) Int. Cl. G06Q 10/06; G06F 3/0481

(52) U.S. Cl. CPC G06Q 10/06316; G06F 3/04817; G06Q 50/24

(57) ABSTRACT

Methods and systems for managing the provision of services facilitate interactive communication among providers of services to present client status and assist in prioritizing tasks. A visual communication board utilizes a touch screen display and software applications display, track, and optimize client progress through a workflow of procedural states or procedural milestones. Icons represent individual clients and securely store client information while visually indicating client status and are self-managed by a plurality of providers in real-time. The visual communication board indicates the utilization of various service resources and client statuses in real-time.

### CROSS REFERENCE TO RELATED APPLICATIONS

This patent application claims the benefit of priority of U.S. Provisional Patent Application No. 61/117,546, filed Feb. 18, 2015, which is incorporated herein by reference in its entirety.

### BACKGROUND

Current health care systems exhibit a wide range of performance inefficiencies that lead to growing costs without value added benefits. Health information technology can provide better efficiency in health care systems and contribute to better outcomes for patients. However, most of the information technology currently available focuses on enterprise level efficiency improvements and little has been done to focus on the labor efficiencies of physicians and front line staff.

A critical part of lean healthcare is to avoid wasted time and effort in the workflows of clinicians and staff. Searching for or waiting for team members, information, or communication opportunities are some of the principle causes of wasted time and patient delays in the front lines. At present, the tool used for such visual communication is a manual white-board that is hung in the hallway of each clinic. The whiteboard is used to track patients through healthcare clinics and to communicate their status to all members of the care team, including in clinics, operating rooms, and inpatient units. Examples of manual white-boards and associated methods can be found in the inventor's own previous publications, Suneja, et al. LEAN DOCTORS: A Bold and Practical Guide to Using Lean Principles to Transform Healthcare Systems, One Doctor at a Time. (2010) and Han, et al. Make Your Clinics Flow with Synchrony: A Practical and Innovative Guide for Physicians, Managers, and Staff. (2016), both of which are hereby incorporated by reference in their entireties.

Visual communication in a healthcare clinic is helpful for physicians to know which task should be addressed next. For example, without visual communication, a physician comes out of an exam room and does not have a clear picture of who is next in line to be seen. Sometimes a clinic assistant might act as a traffic director and tell the clinician which room is next, or perhaps the physician goes into a room because the physician sees charts outside the exam room indicating that a patient is waiting. Sometimes patients come out of exam rooms to question the wait time and check on their own status. In all of these cases, the physician is either guessing what the next priority is or can be easily taken off course by unscheduled activities. The physician is dependent on verbal updates about patient status—updates that may or may not be current. The same confusion impacts the rest of the clinic staff as well. If the nurses, residents, and physicians assistants do not know the status of each patient in the clinic, there is unnecessary checking, delay, and frustration in the process. There are wastes that increase patient wait times, lower patient satisfaction, and create stress for staff as well.

Despite the importance of visual communication, current solutions are limited to manual white-boards which are not always up to date, do not foster ownership and interaction by multiple clinicians, and are limited in the conveyed information. Therefore there is a need in the field for improved visual communication tools.

### BRIEF DESCRIPTION OF THE DRAWINGS

FIG. 1 is a system diagram that depicts and exemplary embodiment of a system for administering services from a provider.

FIG. 2 depicts an exemplary embodiment of a graphical user interface for managing healthcare provider workflows.

FIG. 3 is a flowchart that illustrates an exemplary embodiment of a method of managing healthcare provider workflows.

FIG. 4 is a flowchart that illustrates an additional exemplary embodiment of a method of managing healthcare provider workflows.

FIG. 5 is a flowchart that illustrates an exemplary workflow of a clinician.

FIG. 6 is a flowchart that illustrates an exemplary workflow of a doctor.

FIG. 7 is a flowchart that illustrates and exemplary embodiment of a method of evaluating healthcare provider workflow quality.

FIG. 8 is a flowchart that illustrates and exemplary embodiment of a method of an automated patient survey and analysis.

FIG. 9 depicts an additional exemplary embodiment of a graphical user interface.

FIG. 10 depicts an exemplary embodiment of a patient icon.

FIG. 11 depicts an exemplary embodiment of a window with a graphical user interface.

### BRIEF DISCLOSURE

An exemplary embodiment of a method of managing healthcare provider workflow includes providing a graphical user interface (GUI) and at least one graphical display. The GUI includes a grid having a plurality of spaces arranged in rows and columns. The rows designate one of a physical location or a procedural state for a patient receiving care. The columns designate the other of the physical location or the procedural state for the patient receiving care. A patient file is created. The patient file stores information for an individual patient of a plurality of patients. The patient file comprises a patient icon and the patient icon is positioned on the grid. The position of the patient icon corresponds to a physical location and a procedural state of the individual patient represented by that patient icon. A progress timer is started when the patient icon is positioned in the grid.

An additional exemplary embodiment of a method of managing healthcare provider workflow includes providing a real-time communication board that is accessible to a plurality of caregivers. A plurality of patient icons are provided on the real-time communication board. Each patient icon in the plurality of patient icons represents an individual patient in a plurality of patients. Each patient icon represents a patient file configured to store a patient ID and a note for the individual patient. A workflow is defined to include a plurality of procedural milestones. The procedural milestones begin with at least a queue milestone and end with at least a discharge milestone. The workflow is displayed on the real-time communication board. A current procedural milestone within the workflow is displayed on the real-time communication board for each individual patient. Each individual patient is moved to a next procedural milestone upon completion of the current procedural milestone. The next procedural milestone becoming the current procedural milestone. A progress timer is displayed on the real-time communication board for each individual patient. In one embodiment, the progress timer includes a procedure timer that represents in real-time the time that the individual patient has been waiting to complete the current procedural milestone. In other embodiments, the progress timer includes a total time timer that represents in real-time the total time since the individual patent checked into the system. Alternatively, the procedural timer may include both the procedure timer and the total time timer. Resources are assigned to execute the current procedural milestone of one of the plurality of patients based upon the current procedural milestone, the progress timer, and the note for each of the plurality of patients displayed on the real-time communication board.

An exemplary embodiment of a system for administering services from a provider includes a real-time communication board that is accessible to a plurality of provider personnel. A client file unit includes a client file memory and creates a plurality of client files and stores the plurality of client files in the client file memory. Each of the plurality of client files represents an individual client from a plurality of clients. A client identification and a note are storable within each of the plurality of client files on the client file memory. Each of the plurality of client files includes a client icon and the client icon visually represents the client file on the real-time communication board. A workflow unit includes a plurality of procedural milestones that include a queue milestone and a discharge milestone. The plurality of milestones are viewable on the real-time communication board. A client status unit stores a current procedural milestone for each individual client in a client status memory. The current procedural milestone indicates which of the plurality of milestones the individual client is waiting to complete. Each individual client starts with the queue milestone as the current procedural milestone and each individual client is moved to a next procedural milestone upon completion of the current procedural milestone. Upon completion of the current procedural milestone, the next procedural milestone becomes the current procedural milestone. The current procedural milestone for each individual client is viewable on the real-time communication board. A progress timer as discussed above is viewable on the real-time communication board. Resources are assigned to execute the current procedural milestone of one of the plurality of clients based on the current procedural milestone, the progress timer, and the note for each of the plurality of clients displayed on the real-time communication board.

### DETAILED DISCLOSURE

The embodiments of the visual communication board as described herein employ a series of methods enabled by hardware and software applications to eliminate previous “blind spots” (e.g. current locations of the patient, staff and clinicians; rooms and equipment utilization; number of waiting patients; bottlenecks, etc.) in the daily clinic operation and enable streamlining of process flow. The method and system as disclosed herein visually conveys each next step of patient care to each responsible clinician (also referred to herein as a caregiver), even at long distances (or off site), while offering an added solution for communication. Similarly, the disclosed systems and methods may be used to track, capture, convert, and display real-time process performance data that is pertinent to informed decision-making and efficient daily operations. The performance data, once collected and displayed, assists health care workers in anticipating and resolving patient flow issues, ensures that high level providers—clinicians and others—can utilize their time efficiently, and tracks opportunities for process improvement. Additionally, the data gathered will allow cognitive planning for the healthcare system on how to best balance physician productivity, patient volume, patient experience, and staff level.

Embodiments of the visual communication board system and method disclosed herein may help to eliminate waste in personnel productivity by introducing capabilities for all members of a care team to monitor the status of patients in real-time, enabling all members of the care team to update and modify the patient status in real-time. This, along with providing new ways for members of the care team to communicate, enables the care team to operate efficiently and to prioritize next service steps.

Specifically, the method is based on utilization of hardware and software that serve as a healthcare provider decision support tool. These tools engage caregivers through non-verbal communication and interaction, allow providers to monitor the progress of each patient, clinician, and staff member, and allow providers to measure and analyze patient and staff flow, as well as workflow challenges, through a satisfaction survey tool.

It should be recognized that while the discussed methods and systems are generally described as pertaining to healthcare providers, these are equally applicable to any other service provider or to manufacturers (for example, automobile service, aircraft manufacturing, social services, or banking services).

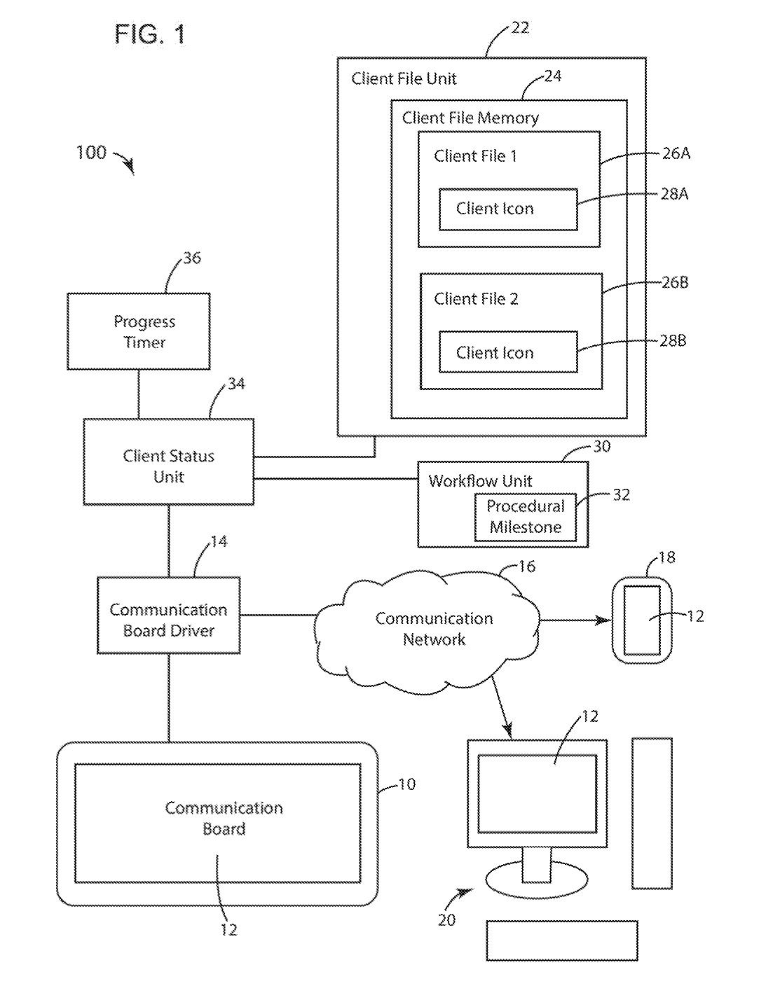

FIG. 1 depicts an exemplary embodiment of a system for administering services from a provider to a client 100. The system 100 includes a communication board 10. As described in further detail herein, the communication board 10 may be one or more communication boards which are digitally operated graphical displays. The communication board 10 is a graphical display that operates to present a graphical user interface (GUI) 12 that conveys relevant information to providers and/or clients regarding the status of and/or progression of the delivery of a service. In exemplary embodiments the communication board 10 may further be operable to receive touch sensitive or other inputs from the user, such as voice recognition, radio frequency (RF) inputs, or thumb print recognition, and thus may further be used as a user input device for a provider to interact with the system 100.

The communication board 10 is operated by a communication board driver 14 which is exemplarily embodied by a computer executing software to cause the communication board 12 to operate in the manner as described in further detail herein. The communication board driver 14 may be connected by a communication network 16 to a variety of other computing devices including, but not limited to mobile computing devices 18 and desktop computing devices 20. Through such communicative connection, the mobile computing devices 18 and desktop computing devices 20 may be operated to also present the graphical user interface 12 and the communication board as described in further detail herein. In such embodiments, all versions of the communication board GUI 12 may be operable in synchronization such that remotely located providers can receive and interact with the information of the communication board GUI 12 simultaneously. In an exemplary embodiment, providers and/or locations may each have a computing device operating a communication board GUI so that each provider can interact with the system to keep the information up to date.

In exemplary embodiments, the communication network 16 may be any of a variety of known communication networks and connected in wired or wireless communication technologies, including, but not limited to Ethernet, Wi-Fi, Bluetooth, and cellular data communication platforms.

The system 100 further includes a client file unit 22 which includes a client file memory 24. The client file unit 22 is exemplarily embodied in computer software stored on and executed by a computer processor in which the client file unit 22 operates to relate client files for any clients to be served by the provider within the system 100. For each client, a client file 26A, 26B is created and stored within the client file memory 24. Each client file represents an individual client to be served by the provider within the system. The client file 26A, 26B can include at least client identification and a client icon 28A, 28B.

Additionally, the client file is capable of receiving and storing at least one note, as explained in further detail herein, created by a provider. In still further exemplary embodiments, the client file may be modified to include at least one color-code and/or at least one symbol, such as but not limited to an emoticon, as will be described in further detail herein. The notes provide communication between providers, presenting complex information regarding both clients and resources in a manner that empowers staff members to make decisions before engaging with a particular client. Reviewing these notes may be prioritized for the provider and staff as “just in time” communication as agreed upon by the staff. Currently, prioritization and other communication are accomplished through verbal discussions, hand-written physical sticky notes, or digital notes buried in electronic medical record systems (EMRs). Physical sticky notes may fall off and become displaced and notes buried in EMRs may be missed. Furthermore, these are unable to be accessible at multiple locations and updated in real-time. Likewise, verbal conversations are often not possible due to time constraints, or postpone the delivery of care due to differing schedules among providers.

Exemplary embodiments of the system 100 may optionally include a workflow unit 30 that is embodied in computer software stored in a computer memory and executed by a computer processor. The workflow unit 30 operates to create, modify, and store procedural milestones. As will be explained in further detail herein, procedural milestones are events or actions to be performed by the provider for the client. A plurality of procedural milestones in a predetermined order may similarly be saved as a workflow. In an exemplary embodiment, specific workflows may be saved for particular services which the provider may perform for a client. In an exemplary embodiment, a workflow may include at least a queue milestone and a discharge milestone. The workflow may begin with the queue milestone, for example when a patient arrives and is checked in to a clinic, and end with the discharge milestone, for example when the patient's service is complete and leaves the clinic. In such embodiments, at least one additional procedural milestone (e.g. seeing a nurse and/or a physician, x-ray imaging, laboratory tests, etc.) is present between the queue milestone and the discharge milestone.

A client status unit 34 is exemplarily embodied in computer software stored in a computer memory and executed by a computer processor, to carry out the functions as described herein. The client status unit receives client files 26 from the client file unit for each of the clients to be serviced in a given predetermined timeframe. This timeframe may exemplarily be one business or working day (e.g. during normal working hours). The client status unit 34 connects each received client file with a workflow comprising a plurality of procedural milestones 32 from the workflow unit 30. The client status unit operates with the communication board driver 14 to present the client icon 28A, 28B associated with the client files of the clients to be serviced on the communication board as will be described in further detail herein. The client status unit 34 further tracks the status of the client between at least one of the physical location, a procedural state, or a procedural milestone for each of the client files. The client status unit 34 can receive inputs for any of the computing devices presenting the communication board GUI to receive an update or change to the client's status (e.g. physical location, procedural state, or procedural milestone).

The client status unit is further connected to a progress timer 36 which operates for each of the client files being processed by the client status unit 34. In exemplary embodiments, the progress timer 36 monitors an elapsed duration for an entirety of a workflow (e.g. from a queue milestone to a discharge milestone). The progress timer 36 is also operable to measure an elapsed time between procedural milestones for the client. In one embodiment, the progress timer 36 exemplarily operates at least a first timer and a second timer for each of the received client files. As explained in further detail herein, the first timer can measure an elapsed time between changes in location, procedural state, or procedural milestone. The second timer can measure an overall elapsed time.

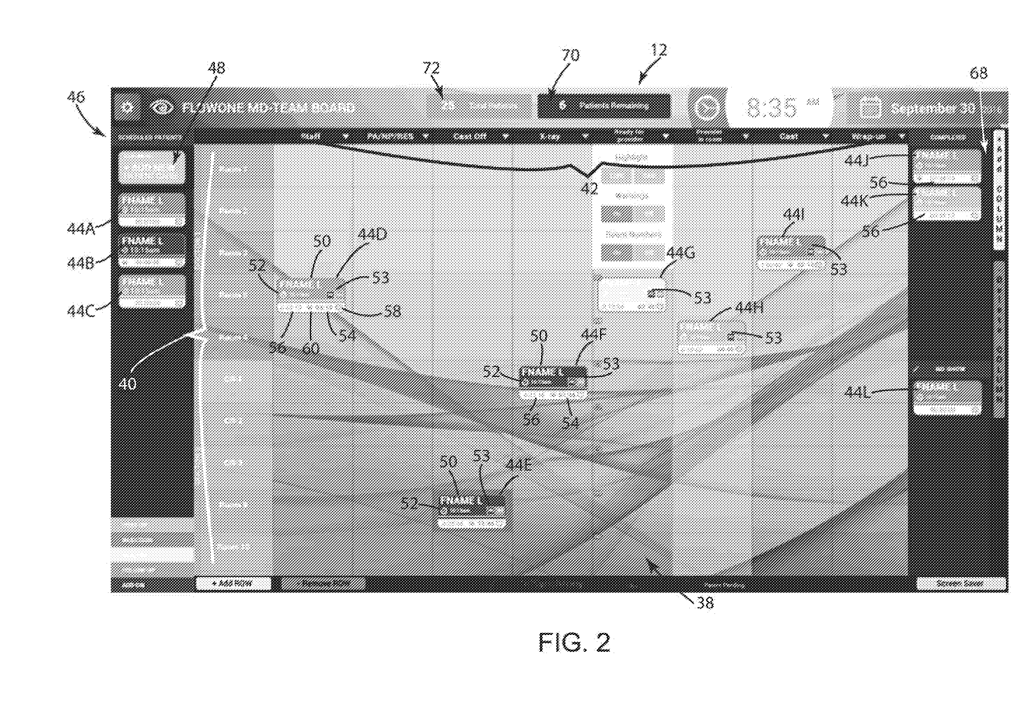

FIG. 2 depicts an exemplary embodiment of a graphical user interface (GUI) 12 for managing healthcare provider workflow within the system 100 (FIG. 1). In some cases, a provider will configure the GUI to arrange the patient icons according to their appointment time in a scroll type system. As the arriving patients are placed in the waiting room or exam rooms, the remaining scheduled patients scroll up according to their schedules. As the day progresses and patients are treated, caregivers can see the count of all treated and all remaining patients. A patient countdown bar may also be provided to indicate the status of the seen versus expected patients so the clinician and the staff can pace their workflows, as is discussed in greater detail herein.

The GUI 12 of FIG. 2 includes a grid 38 made up of a plurality of rows 40 and columns 42. In the exemplary embodiment depicted in FIG. 2, the rows identify a plurality of locations for the client to receive service while the columns 42 each indicate a procedural state in receiving that service. The GUI of FIG. 2, as well as the remainder of the examples used herein, will relate to the service of healthcare where the provider is a healthcare provider, otherwise referred to as a clinician, and the client is a patient. However, it will be recognized that in other fields or industries, the same system may be used to manage the division of services to other forms of customers or clients.

The GUI 12 further includes a plurality of client icons, which in the present embodiment are patient icons 44A-44L. Exemplarily, the GUI 12 includes, along the left hand side, a column or list of scheduled patients 46 as depicted by a listing of patient icons 44A-C. Exemplarily, these are patients who are scheduled for appointments, but who have not yet arrived or checked in to the medical care facility. In another embodiment, these may be patients who have checked in and are currently waiting for service. Button 48 enables a user such as a clinician to interact with the system to add a new patient either exemplarily to create an entirely new client file or to access an already created client file for inclusion on the GUI 12. Relating the GUI 12 back to the system 100 shown on FIG. 1, such an action to add a client file may provide that client file to the client status unit 34 for management of the status of the patient facilitated by the GUI 12.

In an exemplary embodiment as disclosed herein which uses saved workflows of procedural milestones, the list of procedural states making up the columns 42 of the grid 38 may exemplarily be procedural milestones as may be accessed from the workflow unit. Exemplarily, each patient may need a subset of the depicted procedural states in a workflow assigned to that patient, as in the service received by the patient. As the patient is checked in, the patient icon 44 is moved from the scheduled patient column 46 to the appropriate location on the grid to identify the location and procedural status of that patient. For example, patient icon 44D represents one of the patients who has checked in to the facility and is currently speaking to a staff member in Room 5. Patient icon 44H indicates that that patient is in Room 4 along with a clinician.

The patient icons 44A-L provide valuable information to a provider or providers in managing the provision of services to a patient or client. The patient icon 44 includes a patient identification 50 and a scheduled appointment time 52. It will be recognized that in embodiments, the patient identification 50 may be presented in a HIPPA compliant manner, for example initials, or first initial and last name, or abbreviated last name. One or more provider icons 53 indicate when a provider is currently with the patient. The provider icons 53 are exemplarily placed by the provider with an input to the communication board GUI. Therefore, each provider takes ownership of their location and current patient task, thereby keeping the communication board up to date in real-time.

The patient icon 44 further includes a procedure timer 54 that is exemplarily an elapsed time since there has been a change in the patient's location and/or procedural status. This may exemplarily be tracked as a component of the progress timer (FIG. 1). The patient icon further includes a total time timer 56 that represents an elapsed time since the patient was checked into the system. This exemplarily may be tracked by another component of the progress timer. Additionally, the patient icon may provide an indication 58 if one or more notes are available in the associated patient file. The patient icon may further include a symbol 60 such as an emoticon which may exemplarily be connected to a clinician input or to an input from the patient and represent a general mood or other indication regarding the patient.

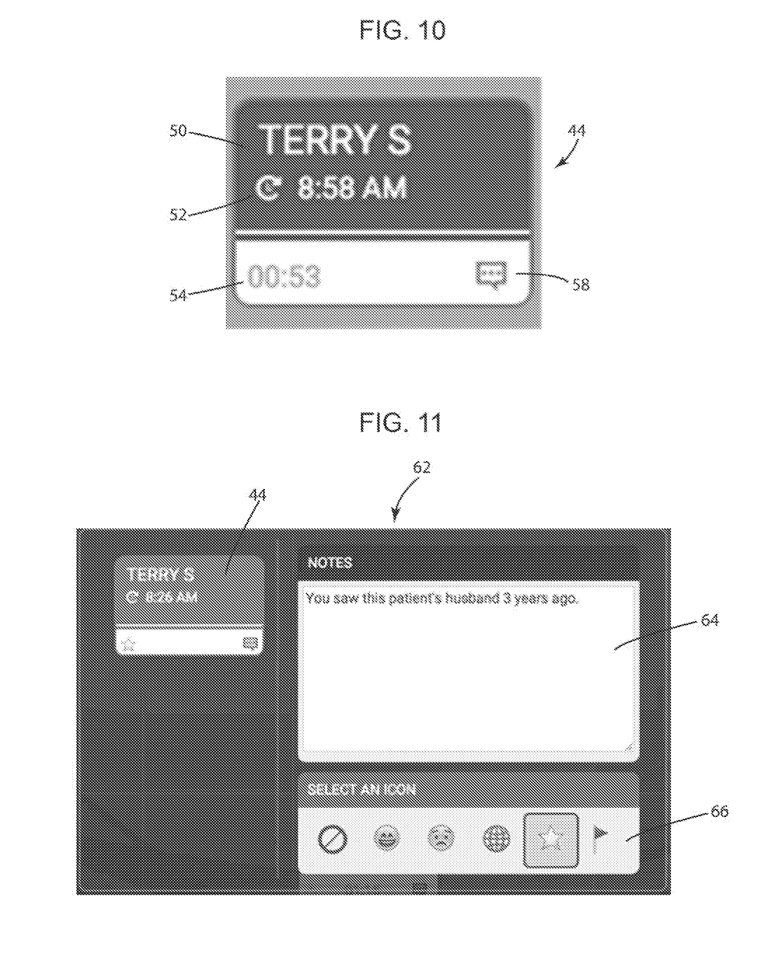

A patient icon 44 is shown in greater detail in FIG. 10. For example, because the patient icon 44 does not depict a provider icon, this indicates to everyone viewing the communication board that no provider is currently with the patient. Exemplarily, the procedure timer 54 keeps track of how long the patient has been in the given location and/or procedural step. In embodiments, the times for various procedural steps, or procedural milestones, in the workflow may be recorded such that general estimations regarding the timing for certain tasks can be known and anticipated. Therefore, for example if the step currently represented by the patient icon 44 normally takes ten minutes, then a caregiver associated with a next step in the workflow may know that there is sufficient time to see a subsequent patient before returning to see this patient. Additionally, such estimation gives the general information that Room 3 will be available in approximately nine more minutes. From this information, a person in charge of scheduling and room and/or other resource allocation is empowered to make real-time decisions in allocating resources such as rooming a patient.

Referring back to FIG. 2, and as will be described in further detail herein, as a patient moves along a workflow to another location and/or procedural state, the patient icon is moved within the grid 38 to convey this information to any of the caregivers operating within this system. For example, patient icon 44D may be moved to position of icon 44F if the patient is now receiving or preparing to receive x-ray imaging in Room CR-1. Looking to patient icon 44F, it can be viewed that the procedure timer 54 indicates that the patient has been in this room and this procedural state for one minute and five seconds, while the patient has had an elapsed time of twenty-two minutes and sixteen seconds since being checked into the system.

During the course of care or other service, a clinician has the opportunity to select a patient icon to gain access to additional information from the associated patient file. This is exemplarily depicted in FIG. 11, which depicts a window 62 exemplarily associated with selection of a patient icon 44. The window 62 exemplarily depicts the associated patient icon as well as a text interface 64 for the clinician to read, write, or edit notes regarding the patient and/or service provided. An interface 66 enables a clinician to select a symbol 60 to be incorporated into the patient icon 44 to further symbolically convey information regarding the patient. In a still further embodiment, as will be described in further detail herein, the symbol 60 may be an icon received from a patient survey which may be electronically administered during the course of the service.

Referring back to FIG. 2, once the service of the patient has been finished, the patient icon 44 is moved to a completed column 68 and the patient icon may present only the total time timer 56 from the entire visit. In a still further aspect, the GUI 12 additionally provides an indication as to the remaining scheduled patients for the day 70 and the total patients scheduled for the day 72. These indications regarding the entire workload and workload progression of scheduled patients further help to inform all caregivers with this general information that can assist in making any numbers of decisions, throughout the day reflective of the current progress against the scheduled workload. Additionally, this contextual information helps clinicians to improve service practices over time while gaining positive or negative feedback regarding workload throughout the day.

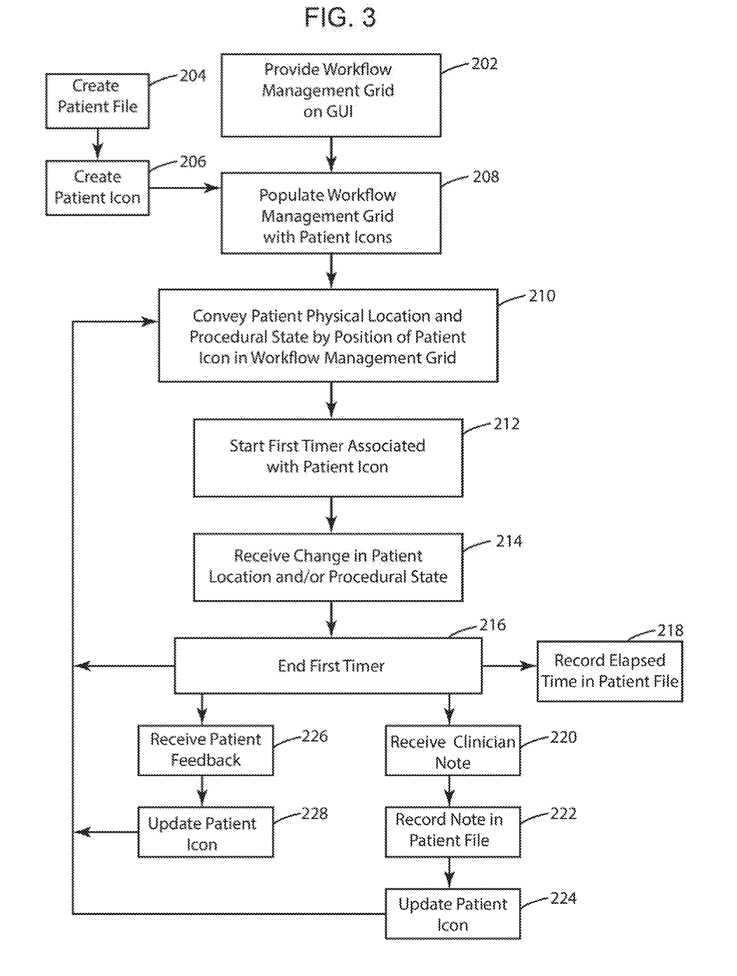

FIG. 3 depicts a flowchart illustrating an exemplary embodiment of a method 200 for managing the workflow of a healthcare provider using a grid such as the one depicted in FIG. 2. The method 200 begins at 202 by providing a workflow management grid such as the GUI 12 shown in FIG. 2. The workflow management grid is made up of columns and rows with one of the columns or rows representing a plurality of locations and the other of the columns or rows representing a procedural state. Next, at 204 a user creates one or more patient files. Each patient file includes information such as patient identification and is configured to include information such as notes, recorded times (which maybe procedure times or total elapsed times), a selected symbol, or other information. At 206 a patient icon is created for each patient file. The patient icon created at 206 visually represents the patient and the patient file within the communication board system.

The workflow management grid is then populated with the patient icons at 208. Once populated with patient icons, the position of each patient icon within the grid corresponds to a physical location and procedural state within the workflow. As such, patient icons are positioned within the grid in the appropriate position to convey the patient's current physical location and the procedural state that the patient is currently engaged in or is waiting to complete. In the case of a touch screen device to display the GUI, the positioning may be by mouse click or finger touch and drag inputs, for example. Examples of this placement can be seen in FIG. 2, which depicts patient icons 44A, 44B, and 44C in a “scheduled patients” or queue column, patient icon 44D being in the physical location called “Room 5” and awaiting procedures designated as “staff,” and patient icon 44E being in the physical location called “Room 9” and awaiting the procedural designated as “Cast Off,” for example.

It should be noted that additional information may be conveyed by the position of the patient icons within the grid. For example, in FIG. 2, Rooms 1-5 are also designated as be associated with “Doctor 1,” whereas “Doctor 2” is associated with locations CR1 through CR3, and Rooms 9-10. Similarly, more than one patient icon may be permitted to be placed within a given procedural state (for example, the “Scheduled Patients” or queue), which does not require also distinguishing a physical location for these patients. A similar example is also shown for the procedural state “Completed” in FIG. 2.

Once a patient icon has been placed in a position on the grid, at 212 a timer starts counting the amount of time lapsed since the patient icon was placed in that position. In one embodiment, this timer is a “total time” timer that does not stop counting until the patient is discharged. In other embodiments, the timer is a “procedure” timer that resets each time the patient completes a current procedural state and moves on to a next procedural state. In a third embodiment, the timer includes both a “total time” timer and a “procedure” timer.

The timer—whether a “total time” timer, “procedure” timer, or both—may be viewable within the patient icon. In the exemplary embodiment shown in FIG. 2, patient icon 44D depicts the timer as including both a procedure timer 54 and a total time timer 56. In some embodiments, one or both timers will not begin counting until the patient icon is placed within a position on the grid other than the “Scheduled Patients” or queue column. Similarly, some embodiments may only display the total time timer after a patient icon has been moved to the “Completed” column, as there are no additional procedural states awaiting completion. To remain flexible to the needs of each individual clinic, displaying either or both timers on patient icons may be a selectable option, wherein the timer data may be collected and stored in the patient file irrespective of the timer data being displayed.

In some embodiments, an alarm or alarms may be associated with the timer or timers such that one alarm is triggered when one timer exceeds a maximum preset time. Each alarm may be visual (pulsing, flashing), audible (voice, signal), or both, and serve to alert the caregivers for needed care. The alarms (audible or visual) may be presented by the computing device and/or the communication board GUI presented on the computing device.

Meanwhile, while the “procedure” timer and/or “total time” timer continue counting, clinicians and staff provide care to the patients. This continues until there is a change in one of the patient's physical locations or procedural states. At 214, a change to a patient's procedural state is received, exemplarily by a provider input into the communication board system. Upon receiving this change, procedure timer associated with that patient icon may be stopped at 216, indicating that the patient is no longer awaiting completion of that procedural stage. The count from the procedure timer can also be recorded in patient's file at 218 for later analysis. If that patient has not yet moved to the completed procedural state indicating discharge, the procedure timer is restarted. If the change in procedural state and/or location received at 214 is to a new location or procedural state, then the method can return to 210 to convey the new patient location and/or procedural state in the workflow management grid.

Additionally, a clinician may choose to provide additional information to the patient file, such as a note. A clinician note may be received at 220, for example by a clinician selecting a patient icon and opening a note text editing window and typing a note. The note could be selected from a series of pre-populated messages, or could be entered as a custom entry. For example, a clinician may add a note regarding the results of the patient's bloodwork, or simply a reminder that the clinician has also worked with the patient's spouse in the past. The note is then added to the patient file at 222, and the patient icon is updated at 224 to provide an indication on the patient icon to signify that this note is available to view on demand. In the exemplary grid of FIG. 2, this is signified by indication 58 is as shown on patient icon 44D.

Additionally, feedback for the patient may be received at 226 during or after the completion of a procedural state. In some embodiments, this feedback may constitute a patient survey to provide patient feedback regarding the overall process and care received. The results of this patient survey may be compiled and viewable to providers/clinicians, including staff to help foster improvements for rendering care in the future. This may be represented by a symbol added to the patient icon. Once the patient feedback is received at 226, the patient icon may be updated with the symbol at 208.

In other embodiments, other patient feedback may be received during or after a patient receives care. In this case, a clinician may choose to select a symbol such as an emoticon to be included in the patient file. The symbol (e.g. emoticon) functions in the same manner as a note, conveying additional information about the patient, but does so through the use of a symbol such as a happy face, sad face, or angry face, for example. Specifically, the emoticon provides a quick means of conveying how the patient is currently feeling, which may also be included in the patient icon to be viewable on the grid. Alternatively, a patient's emoticon could be selected automatically, beginning as a happy face and proceeding to neutral and sad faces as the patient's wait time increases. An automatic emoticon could also be overridden manually to indicate such feelings as anger. One example of an emoticon displayed in a patient icon is shown in FIG. 2, wherein a symbol 60 is shown in patient icon 44D, shown here as a happy face.

Following any changes to the physical location and/or procedural state of a patient, or to the notes and emoticons associated with a patient, any affected patient icon and/or the position of such icons are updated to properly convey these changes. In this regard, the grid is updated in real-time such that the information being displayed in the grid remains accurate throughout the administration of each patient's care.

It should be noted that the patient icons displayed within the grid may display additional information not previously discussed. For example, different types of patients (New, Follow-Up, Research, Other) may be displayed in color-coded patient icons to allow the clinicians to estimate the preparation time needed before walking into the exam room. The color coding may also allow the staff to prioritize work and be available based on anticipated patient needs. For example, follow-up patients may be designated by one color, which caregivers using this method may recognize means that they and do not require as many resources as patients with an injury or needed procedure, or new patients, which would each be designated different colors. In this regard, the color for each type of patient may be selected by each clinic based on the clinic's specific needs. The grid of FIG. 2 depicts patient icon 44D, showing the patient's scheduled appointment time 52, as well as the patient icon being color-coded, for example blue, which may mean the patient is a “follow-up” patient in accordance with the key exemplarily shown in the lower-left corner of the grid.

In some embodiments, the patient icons will also reflect the provider icon 53, which may include initials of any clinicians currently rendering care to that patient. For example, patient icon 44D of FIG. 2 depicts that “PC” and “KH” are each currently with the patient associated with patient icon 44D. In this regard, the addition of provider icons 53 to patient icons 44 permits users of the grid to track the current location of each provider in real-time.

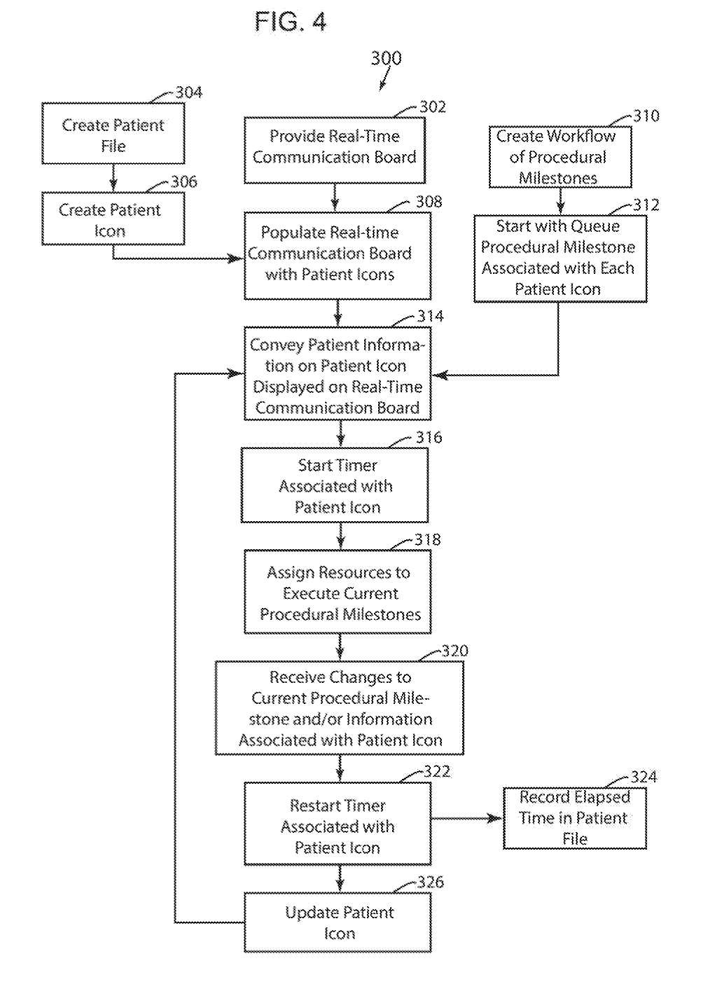

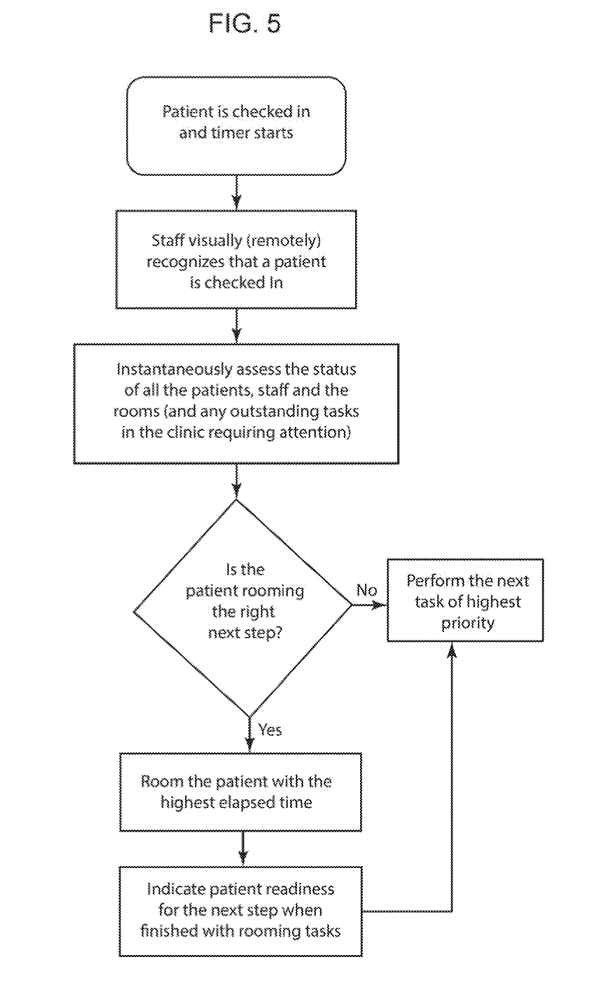

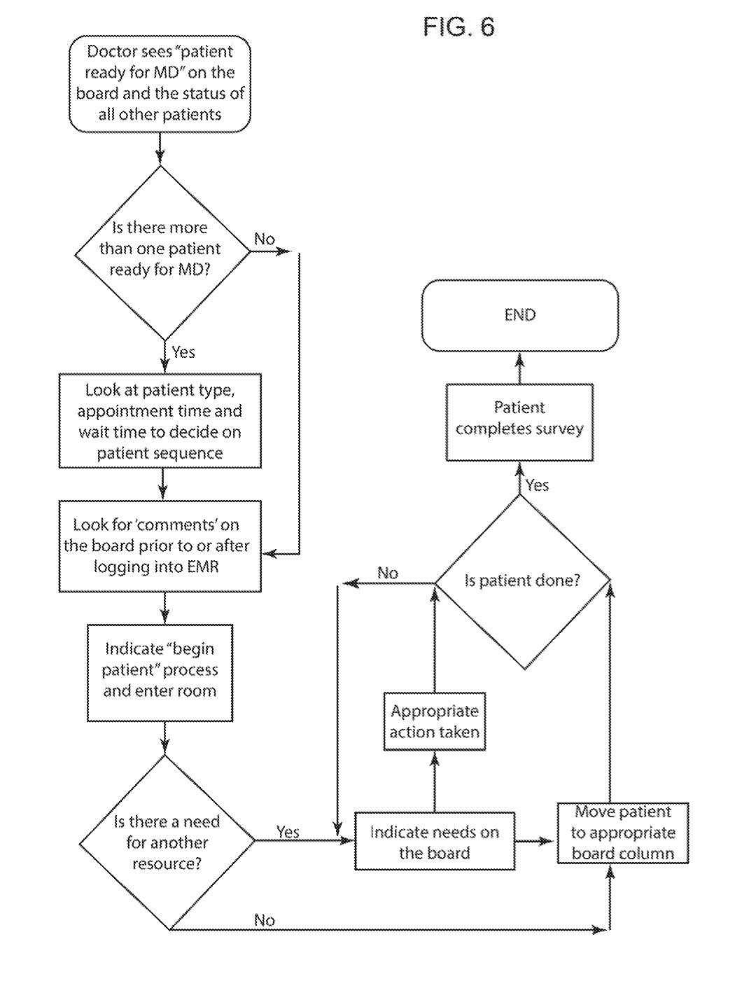

FIG. 4 depicts a flowchart illustrating another exemplary embodiment of a method 300 for managing the workflow of a healthcare provider. In the same regard as the method 200 shown in the flowchart of FIG. 3, the present method 300 begins at 302 by providing a real-time communication board (board), for example, the GUI depicted in FIG. 2. It should be noted that in the exemplary embodiment depicted in FIG. 4, the real-time communication board does not necessary constitute a grid as shown in FIG. 2.

Next, at 304, a user creates on or more patient files in the same manner described for the method 200 shown in FIG. 3. At 306, a patient icon is created for each patient file. The patient icon created at 305 visually represents the patient and the patient file within the board.

Similar to the flowchart provided in FIG. 3, the board is then populated at 308 with patient icons created at 306. In addition to patient files, a workflow of procedural milestones is also created at 310, beginning with a “queue” milestone at 312 and ending with a “completed” milestone. Once populated with patient icons, the position of each patient icon within the board conveys at 314 information regarding the patient through the patient icon created at 306 and the current procedural milestone of the patient as indicated by the patient icon position within the board, all in real-time.

As mentioned above, the workflow may comprise a series of procedural milestones. Different patients may have different workflows comprising possibly different procedural milestones, or procedural milestones in different orders. In an embodiment, the procedural states presented in the grid of the communication board may update to reflect those procedural states currently occupied by patients. In another embodiment, the grid may update to present as the procedural states all of the procedural milestones of the workflows associated with the patients currently in the grid.

As with the method 200 depicted in the flowchart of FIG. 3, at 316, a timer is started when a patient icon is first positioned on the board. This timer may be a “procedure” timer, a “total time” timer, or both a procedure timer and a total time timer. Similarly, the timer or timers may be configured to be viewable on the patient icon, or discretely recorded in the patient file without display (for example, at 324). Once again, each timer may be associated with an alarm as discussed above.

Similarly, the patient icon may contain other viewable information, including notes, emoticons, scheduled appointment time, or a provider icon to indicate when a provider is currently working with the patient, as discussed above.

In the exemplary method 300 depicted in FIG. 4, resources are assigned to patients at 318 to render care towards completing one or more patients' current procedural milestones based on the information conveyed on the board. In this regard, patient priorities may be determined based on any or all of the real-time information depicted by the patient icons, empowering caregivers to make necessary adjustments ad hoc.

As resources and caregivers continue to provide care to the assigned patients and milestones are completed, the current procedural milestone of these patients will change. Similarly, the notes, emoticons, and timers associated with each patient icon may change as time passes. Accordingly, the board is configured to receive at 320 information about these changes in real-time. If such a change is related to the completion of a procedural milestone and there is a procedure timer in use icon, the procedure timer for that patient icon will restart at 322 to reflect the start of a new, current procedural milestone. At 324, the prior time of the procedure timer may be recorded in the patient file for later analysis. However, any total time timers in use with the associated patient icon will not reset, as the total time timer reflects the total elapsed since the patient icon was first positioned on the board.

Much like the method 200 depicted in FIG. 3, changes related to the information depicted in the patient icon and/or the current procedural milestone associated with the patient are updated on the board at step 326 to reflect the changes to the patient icon and the position of the patient icon on the board. In this manner, the board remains an accurate, real-time tool for managing healthcare without the need for in-person conversations and other non-value-added delays.

The methods disclosed may utilize hardware in the form of an interactive medium—a touch screen display that is placed in a location clearly visible at long distances and self-managed by the caregivers, staff, and providers generally. The board can be viewed on any type of hand-held device or a computer with the capability of remote access. In one embodiment, remote access may be enabled by allowing the software to be downloaded from the cloud to a variety of hardware devices. The secured and password protected application has the ability to be self-modified by caregivers to meet the specific needs of any clinic. This also gives clinicians the ability to update their own states (e.g. seeing a patient) or the status and/or location of a patient (e.g. procedural state complete) from any number of networked devices in the healthcare facility or with a personal computing device operating in the system.

Through extensive experimentation, the inventor has determined that using the systems and methods disclosed to display real-time information on the board helps prioritize work tasks for each worker without the need for prompting or in-person communication by a team leader, clinician, or supervisor. At any given moment, each caregiver knows the whereabouts of every other team member and care status of every patient. The displayed information aids staff members and clinicians not only with setting priorities and making decisions for every next step of the process, but also with the ability to foresee, and when feasible, immediately rectify problems.

The board can be utilized to develop future patient schedules or make staffing decisions based on the workload demand patterns captured. When a follow-up patient visit is required and scheduled, that patient's icon is automatically stored in the scheduled date for future use. The patient icon, with all of the associated information, can be stored in the database indefinitely for future use.

The board can be networked, accessed, updated, and viewed in provider clinics, as well as support departments such as radiology, labs, patient check-in, etc.

In this regard, caregivers in the clinic (and remote team members) are engaged in the process and are empowered to make improvements or changes as necessary in real-time. This ability to see and respond to every situation helps to control the flow of patients through the clinic, reducing patient wait times and increasing clinician and staff efficiency, leading to greater staff and patient satisfaction.

Additionally, the updated board may be communicated to non-caregivers, such as patients or those waiting for patients, to provide real-time estimates for the time that a patient is expected to start and/or finish receiving care. In one embodiment, such information could be communicate to potential patients to aid in the potential patient's decision to seek care at that point in time, for example, for walk-in clinics.

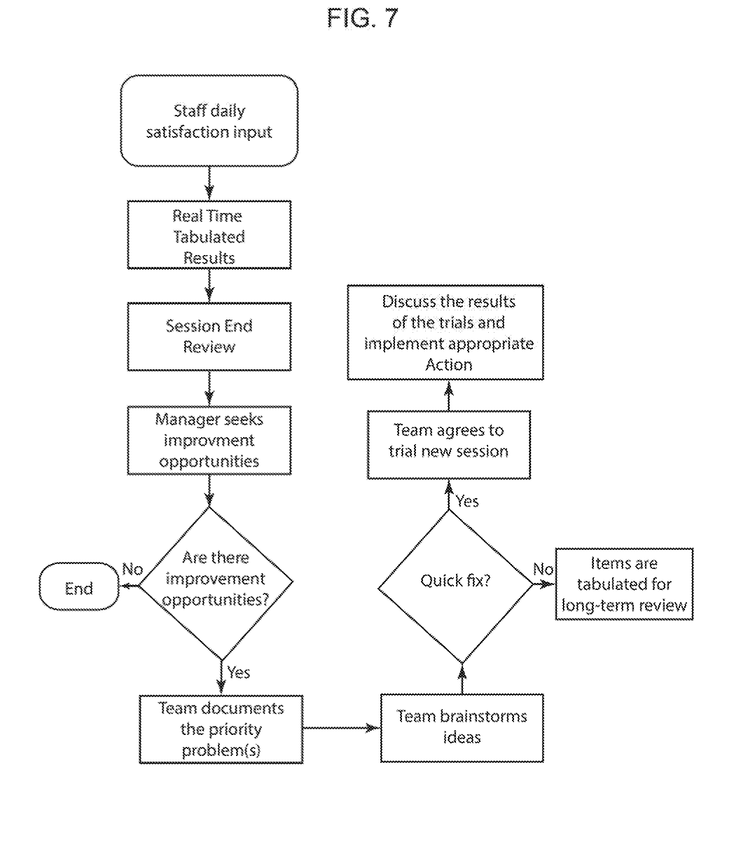

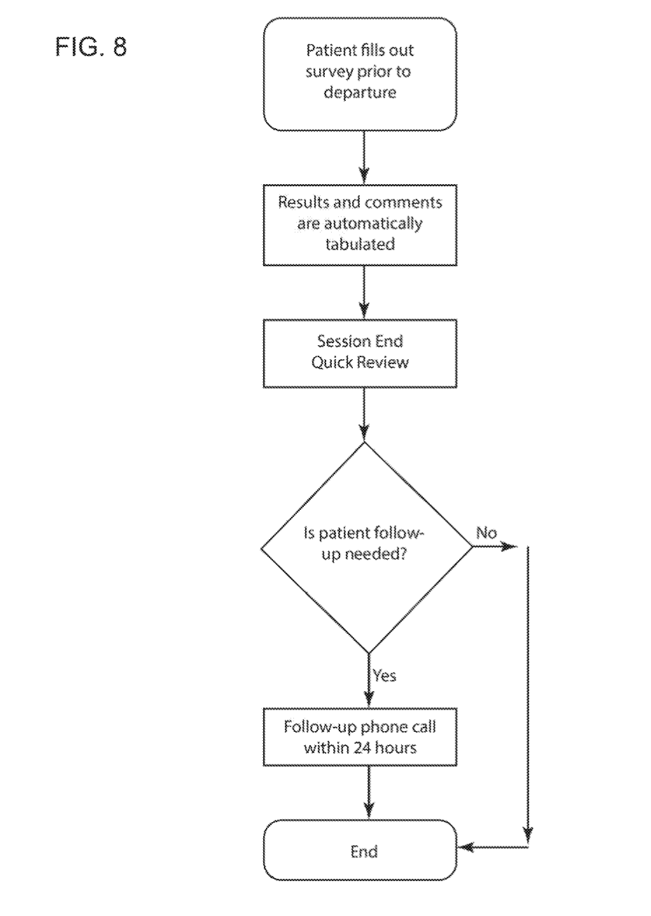

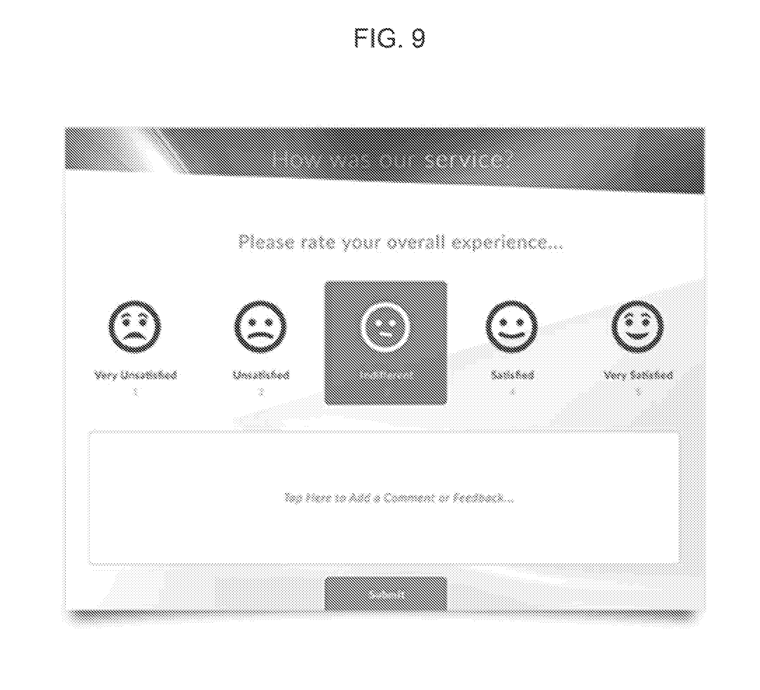

In one embodiment of the method and system, patients have the ability to complete a satisfaction survey while they are in the clinic, or during their check out process (see FIGS. 7-9). The survey is offered to each patient on a preferred choice of electronic device (see FIG. 9). The survey application is configured to allow the survey questions to be developed and modified by the administration, clinicians, or staff members to fit the clinic's specific needs. In embodiments, the survey enables a patient to provide an intra-procedure status of how they are currently feeling. This status may reflect a satisfaction with service or wait time, or an indication of health or pain level.

The data and comments collected from the survey are stored and immediately transmitted onto the board or any other form of electronic device in form of user selected useful data, for example as a symbol on the patient icon. The survey results may be analyzed immediately upon survey submissions. The survey application can also generate notifications to staff members if patient follow-up is appropriate. The data may also suggest if and with whom an appropriate follow-up action needs to be taken (see FIG. 7). As a result, an attempt to rectify patient dissatisfaction can be done immediately.

In additional embodiments, all data from the board or any other electronic device used are collected into a database resident on a computer, another piece of hardware, or in a virtual space. The software retrieves the warehoused data and is configured to convert the data to performance metrics to be displayed on a separate screen of the board in a useful, pre-selected form of analytics or reports. These analytics can be viewed at any time by a finger scroll to the analytics screen, or selecting a different tab in the view screen. This data is continually updated in real-time and displayed in modifiable forms, such as graphs, patient satisfaction scores, patient volumes, and patient wait times. The board also displays real-time data from patient and staff flows. All data is displayed in multiple views accessible by word or the touch of a finger.

Authorized team members and administrators can access real-time analytics describing the clinic's performance and progress via the touch of a finger touch from any remote location with an access to the cloud.

By employing the method provided by the board in a given clinic, the provider may further evaluate the collected data using models to identify the value added time the provider spends with each patient, and to compare that time to the overall patient wait time. Additional models can also be applied to generate other useful analytical reports from the collected data.

Data collected from the method using the board, along with any applied models, can be collected daily and stored in various forms on or off site for future use and analysis. Users can identify trends or problems and up to date reports to administration in any desired format. Since bottlenecks can be quickly identified, immediate remedies can often be implemented.

The visual communication board software can be implemented as a standalone product, or integrated with any enterprise level software that is used within the organization.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of managing healthcare provider workflows, the method comprising:
providing, on at least one graphical display, a graphical user interface (GUI) which comprises a grid having of a plurality of spaces arranged in rows and columns, the rows designating one of a physical location or a procedural state for a patient receiving care, and the columns designate the other of the physical location or the procedural state for the patient receiving care;
creating a patient file, the patient file storing information for an individual patient of a plurality of patients and comprising a patient icon;
positioning the patient icon in the grid, wherein the position of the patient icon corresponds to the physical location and procedural state of the individual patient represented by that patient icon;
starting a progress timer when the patient icon is positioned in the grid, wherein the progress timer represents an elapsed time since the patient icon was positioned in the grid and the elapsed time is presented in the patient icon;
moving the patient icon to a next position in the grid whenever the physical location or procedural status for the individual patient represented by that patient icon changes; and
upon at least one movement of the patient icon to the next position, reporting the elapsed time.

2. The method of claim 1, further comprising:
representing each of the plurality of patients with a patient icon located in the grid; and
prioritizing which of the plurality of patients will receive care next based on the physical location, the procedural status, and the elapsed time indicated by each of the patient icons within the grid.

3. The method of claim 1, wherein the progress timer comprises a procedure timer that represents the elapsed time since the patient icon was last moved.

4. The method of claim 1, wherein the progress timer comprises a total time timer that represents the total elapsed time since the patient icon was first positioned in the grid.

5. The method of claim 1, wherein the progress timer comprises both a procedure timer that represents the elapsed time since the patient icon was last moved and a total time timer that represents the total elapsed time since the patient icon was first positioned in the grid.

6. The method of claim 1, wherein the patient icon displays at least a patient ID and the progress timer.

7. The method of claim 1, wherein the information stored in the patient file is configured to also store an emoticon selected from a plurality of emoticons, wherein the emoticon indicates how the individual patient is feeling.

8. The method of claim 1, wherein the information stored in the patient file is configured to also store a note, wherein the note comprises either a pre-defined message from a plurality of pre-defined messages, or a custom entry, the note being accessible through the patient icon.

9. The method of claim 1, wherein an alarm is triggered when the progress timer exceeds a pre-determined time threshold for the physical location and procedural state corresponding to the current grid position of the patient file.

10. The method of claim 1, further comprising providing a patient satisfaction survey for each of the plurality of patients to communicate a level of satisfaction of the care received by a healthcare provider.

11. The method of claim 1, wherein the patient file is one of a plurality of patient files each comprising a patient icon, and the patient icon is one of a plurality of patient icons positioned in the grid to convey a physical location and a procedural states of each of the plurality of patients, and further comprising:
analyzing the information from the plurality of patient files in the grid to determine a predicted time that one of the plurality of patients will be moved to one or a specific physical location or a specific procedural status.

12. The method of claim 1, further comprising analyzing the information from the plurality of patient files in the grid to determine a predicted time that a new patient not yet receiving care is expected to either start receiving care, or finish receiving care.

13. The method of claim 11, further comprising analyzing the estimated wait time for each of the plurality of patients to determine an estimated start time for an individual patient that has not yet begun to receive care.

14. The method of claim 1, further comprising analyzing the information from the plurality of patient files of patients that received care over a period of time to determine a value-added portion of time and a waste portion of time.

15. The method of claim 1, wherein the at least one graphical display is a real-time communication board that is accessible to a plurality of caregivers, wherein the information storable in each patient file includes a patient ID and a note, wherein the procedural state of each individual patient defines a current procedural milestone of care that the individual patient is waiting to complete within a workflow comprising a plurality of procedural milestones, wherein each patient file is represented as a patient icon that is viewable on the real-time communication board, and wherein resources are assigned to execute the current procedural milestones of the plurality of patients based at least in part on the current procedural milestone, the progress timer, and the note for each of the plurality of patients displayed on the real-time communication board.

16. A method of managing healthcare provider workflow, the method comprising:
providing a real-time communication board that is accessible to a plurality of caregivers;
providing a plurality of patient icons on the real-time communication board, wherein each patient icon in the plurality of patient icons represents an individual patient in a plurality of patients, wherein each patient icon represents a patient file configured to store a patient ID and a note;
defining a workflow comprising of a plurality of procedural milestones, wherein the procedural milestones begin with a queue milestone and end with a discharge milestone, and wherein the workflow is displayed on the real-time communication board;
displaying a current procedural milestone within the plurality of milestones on the real-time communication board for each individual patient, wherein each individual patient is moved to a next procedural milestone upon completion of the current procedural milestone, the next procedural milestone becoming the current procedural milestone;
displaying a progress timer on the real-time communication board for each individual patient, wherein the progress timer represents in real-time the time that the individual patient has been waiting to complete the current procedural milestone; and
assigning resources to execute the current procedural milestone of one of the plurality of patients based on the current procedural milestone, the progress timer, and the note for each of the plurality of patients displayed on the real-time communication board.

17. A system for managing the administration of services, the system comprising:
a real-time communication board that is accessible to a plurality of providers;
a client file unit, wherein a plurality of client files are created and stored, wherein each of the plurality of client files represents an individual client from a plurality of clients, wherein a client identification and a note are storable within each of the plurality of client files, and wherein each of the plurality of client files comprises a client icon and the client icon visually represents the client file on the real-time communication board;
a workflow unit that comprises a plurality of procedural milestones, including at least a queue milestone and a discharge milestone, wherein the plurality of milestones are viewable on the real-time communication board;
a client status unit that stores a current procedural milestone for each individual client, wherein the current procedural milestone indicates which of the plurality of milestones the individual client is waiting to complete, wherein each individual client starts with the queue milestone as the current procedural milestone, wherein each individual client is moved to a next procedural milestone upon completion of the current procedural milestone, the next procedural milestone becoming the current procedural milestone, and wherein the current procedural milestone for each individual client is viewable on the real-time communication board; and
a progress timer that counts in real-time the time that each individual client has been waiting to complete the current procedural milestone for that individual client, wherein the progress timer is viewable on the real-time communication board.

18. The system of claim 17, wherein an emoticon and a color-code are storable in each of the plurality of client files, the emoticon indicating how the individual client represented by the client file is feeling and the color-code indicating additional information regarding the individual client represented by the client file, and wherein one of the emoticon or color-coding is viewable on the real-time communication board.

19. The system of claim 17, wherein resources are assigned to execute the current procedural milestone of one of the plurality of clients based upon the current procedural milestone, the progress timer, and the note for each of the plurality of clients displayed on the real-time communication board.

20. The system of claim 17, further comprising a remote access unit that displays at least a portion of a content set displayed on the real-time communication board on an additional electronic device, wherein a change to the content set made by either the additional electronic device or the real-time communication board is reflected on both the real-time communication board and the additional electronic device.
